(19) United States
(12) Patent Application Publication
(10) Pub. No.: US 2014/0020222 A1
(43) Pub. Date: Jan. 23, 2014

(54) APPARATUS FOR REMOVING PCI BRACKETS FROM EXTERNAL MINI-SAS HD CONNECTORS

(71) Applicants: Alex D. Fornshell, Wichita, KS (US); Raymond S. Rowhuff, Wichita, KS (US); Jeffrey D. Heidel, Newton, KS (US)

(72) Inventors: Alex D. Fornshell, Wichita, KS (US); Raymond S. Rowhuff, Wichita, KS (US); Jeffrey D. Heidel, Newton, KS (US)

(73) Assignee: LSI CORPORATION, Milpitas, CA (US)

(21) Appl. No.: 13/552,528

(22) Filed: Jul. 18, 2012

(51) Int. Cl. B25B 27/14; B23P 11/00

(52) U.S. Cl. 29/426.6; 29/762

(57) ABSTRACT

A bracket is fitted over an external connector that has fingers, such as EMI fingers, that are spring loaded and provide electrical connections between outside panels and the main enclosure of a device. The bracket depresses the EMI fingers and provides ease of removal. A tool is dimensioned so that a user has room to grip it while not interfering with a bracket, such as a PCI bracket, when in use. The tool is dimensioned so that it can be slid over a bracket so as to compress the fingers, such as EMI fingers, and the bracket can be removed without damaging the connector. A cut out may be offset from the center to provide additional surface to grip by a user.

### BACKGROUND OF THE INVENTION

On some electrical products that utilize external connectors, such as Mini-SAS HD external connectors, a bracket may sit over the connector past the spring loaded fingers, such as EMI fingers, on the connector. Once a bracket is put over the fingers, the bracket becomes trapped on the connector and removing the bracket is difficult. Damage to the fingers may result. In some instances, a customer of a board that utilizes external connectors, such as a PCI board, may prefer to swap out the bracket that ships with the board for various reasons. The customer accordingly prefers not to damage the fingers.

### SUMMARY OF THE INVENTION

In an embodiment of the invention, disclosed is a method of removing a bracket from a connector, the method comprising sliding a removal tool over a connector, situating the removal tool so that any fingers on the connector are depressed, and removing the removal tool and bracket from the connector.

In an embodiment of the invention, disclosed is a bracket removal tool comprising a semi-rigid, semi-planar member, said member having an upper portion and a lower portion of the plane and an opening acting as an access for an assembly, said member having sufficient thickness to depress a plurality of fingers on the connector when said tool is fully inserted over said assembly, whereby the bracket is removable with the tool from the assembly.

### BRIEF DESCRIPTION OF THE DRAWINGS

FIG. 1 is an example of fingers.

FIG. 2 shows a connector with fingers.

FIG. 3 shows an embodiment of a removal tool.

FIG. 4 is a perspective view of an embodiment of a bracket removal tool.

FIG. 5 is a top view of an embodiment of a bracket removal tool.

FIG. 6 is a front view of an embodiment of a removal tool.

### DETAILED DESCRIPTION OF THE EMBODIMENTS

A tool is dimensioned so that a user has room to grip it while not interfering with a bracket, such as a PCI bracket, when in use. The tool is dimensioned so that it can be slid over a bracket so as to compress the fingers, such as EMI fingers, and the bracket can be removed without damaging the connector. A cut out may be offset from the center to provide additional surface to grip by a user. The tool may be made of any material, such as acrylic, and may be any color. The tool may be clear or opaque. An opaque tool provides increased visibility in a cluttered environment.

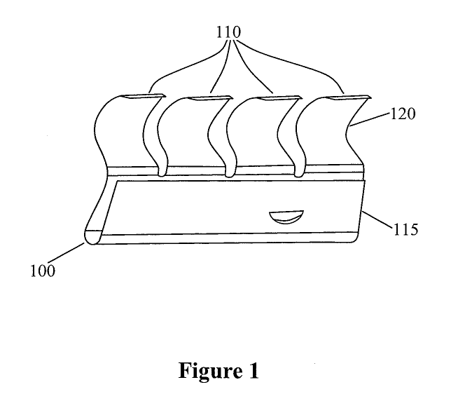

FIG. 1 is an example of fingers. The fingers 100 extend from a base portion 115. The base portion 115 is shown with a means for attaching to connector, such as a Mini-SAS HD connector. The fingers 110 have a curved portion 120 such that the curved portion will contact a bracket when in use. The curved portion will provide constant contact due to a spring-like behavior. It is understood that the fingers can take a variety of shapes and the attachment means can also vary. For instance, the shape of the fingers may be that they extend upward and V at an apex so as to create a similar contact. The attachment means may also be any shape or mechanism that allows the fingers to remain attached to a connector. It is also understood that the fingers may have many more than 4 fingers.

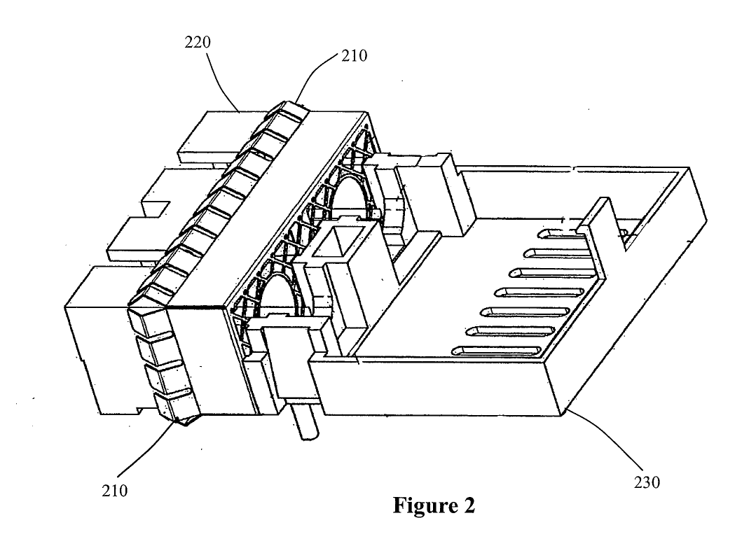

FIG. 2 shows a connector with fingers. The connector 220 has a plurality of fingers 210 that may be spring-loaded. A bracket (not shown) will fit over the fingers 210 when the connectors are inserted. A board, such as a PCI Express Board, extends away from the connectors 220.

FIG. 3 shows an embodiment of a removal tool. The removal tool 310 is placed over the connector 320. The removal tool 310 depresses the fingers 315 (partially visible in FIG. 3 due to being covered by tool 310) and allows the bracket 330 to be removed along with the tool 310. The removal tool 310 is shown in FIG. 1 as a rectangular tool. It is understood that the tool can be constructed in any shape that allows it to slide over the connector and enable removal of the bracket 330. The tool 310 has a hole which may, or may not, be centered. The hole fits over the connector. An un-centered hole allows a user to better grip the tool 310 but is not required for the tool 310 to function properly.

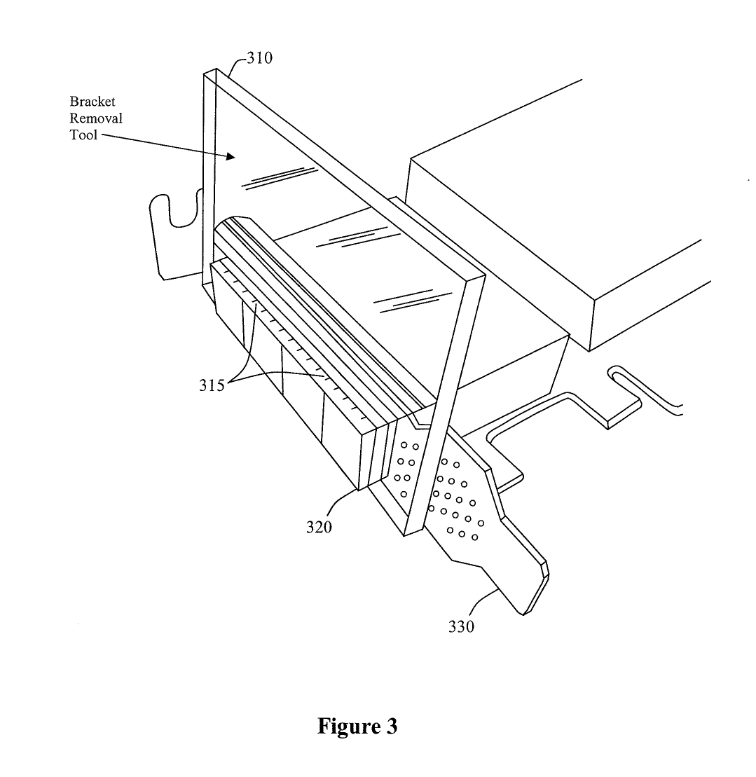

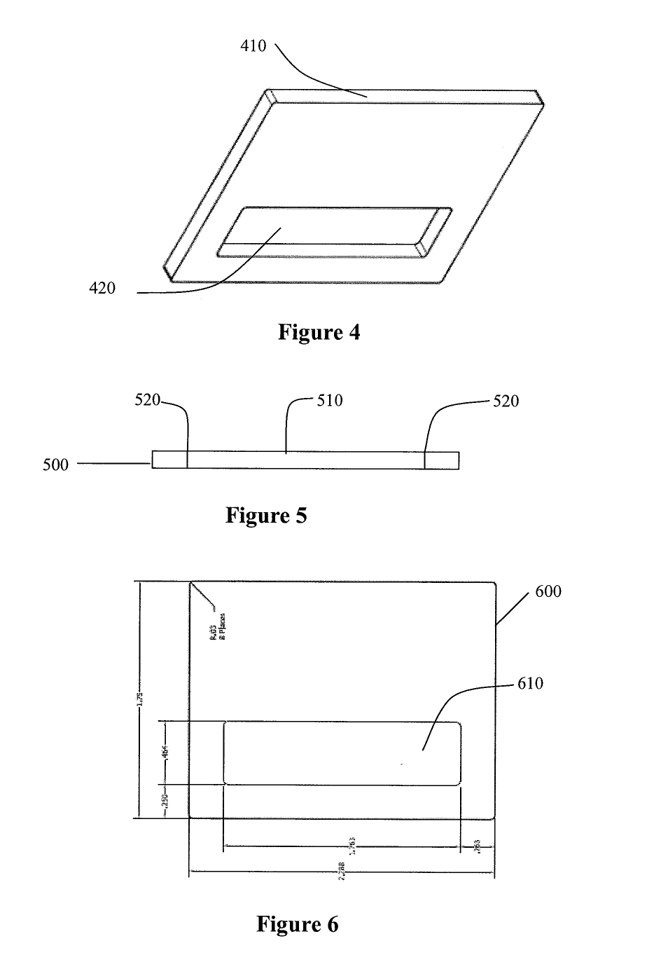

FIG. 4 is a perspective view of an embodiment of a bracket removal tool. The tool is 410 substantially planar and has an opening 420. The opening 420 is sized to provide access for an assembly such as a connector and depress a plurality of fingers that may be affixed to the connector. As noted above, the opening 420 of the tool 410 may not be centered to provide a portion of the tool 410 to be better gripped by a user.

FIG. 5 is a top view of an embodiment of a bracket removal tool. The bracket tool 500 shows how the opening 510 extends for a portion of the width of the tool 500. The lateral edges 520 of the opening 510 are spaced from the edges of the tool to maintain a portion that can be used as a grip.

FIG. 6 is a front view of an embodiment of a removal tool. The tool 600 has an opening 610. The opening 610 may be sized to snuggly fit a connector (not shown). The opening should be large enough to fit over the connector and depress a set of fingers so that a bracket can be removed. As noted above, the tool 600 is dimensioned so that a user has room to grip the tool 610 while not interfering with the bracket when in use. The rectangular opening 610 is off-set from the center of the tool 600 to provide additional surface to grip. The amount of tool 600 that remains above the opening 610 is vary-able depending on user preferences. The tool 600 may be an acrylic material. The tool 600 may also be any material that is suitable to contact a connector and a bracket assembly. The color of the tool 600 may be opaque rather than clear so that will remain visible in a cluttered environment.

In use, a trapped bracket, such as a PCI bracket, is unscrewed from an assembly, such as a PCI Express card. The bracket tool is then slid over the connector, such as a mini-SAS HD connector, and placed against the bracket. This is done so that the tool compresses the fingers, such as EMI fingers, on the connector. The bracket and the tool are then removed together. The tool compresses the fingers enough to allow the bracket to slide off without damage to the fingers. The fingers on the connector are left in-tact and undamaged.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of removing a bracket from a connector, the method comprising:
sliding a removal tool over a connector;
situating the removal tool so that any fingers on the connector are depressed; and
removing the removal tool and bracket from the connector.

2. The method of claim 1, wherein the connector is a Mini-SAS HD connector.

3. The method of claim 1, wherein the connector is a Mini-SAS HD connector and the bracket is a PCI bracket.

4. The method of claim 1, wherein the removal tool comprises a substantially planar member with an opening in said member.

5. A bracket removal tool comprising a semi-rigid, semi-planar member, said member having an upper portion and a lower portion of the plane and an opening acting as an access for an assembly, said member having sufficient thickness to depress a plurality of fingers on the connector when said tool is fully inserted over said assembly, whereby the bracket is removable with the tool from the assembly.

6. The tool of claim 5, wherein said bracket comprises a PCI bracket, said fingers are EMI fingers and said connector comprises a Mini-SAS HD connector.

7. The tool of claim 5, wherein said tool is constructed of a rigid plastic.

8. The tool of claim 5, wherein said tool is constructed of acrylic.

9. The tool of claim 5 wherein said opening is not centered between said upper and said lower portions.

10. The tool of claim 5, wherein said bracket comprises a PCI bracket, said fingers are EMI fingers, said connector comprises a Mini-SAS HD connector and said opening is not centered between said upper and said lower portions.

11. The tool of claim 5, wherein said planar member is opaque.

12. The tool of claim 5, wherein said bracket comprises a PCI bracket, said fingers are EMI fingers, said connector comprises a Mini-SAS HD connector, said opening is not centered between said upper and said lower portions and said planar member is opaque.
